(19) United States
(12) Patent Application Publication
(10) Pub. No.: US 2026/0046616 A1
(43) Pub. Date: Feb. 12, 2026

(54) SYSTEM AND METHOD FOR SECURE COMMUNICATION BETWEEN A DEVICE AND AN APPLICATION SERVER

(71) Applicant: JIO PLATFORMS LIMITED, Ahmedabad (IN)

(72) Inventors: Dhananjaya LANKALAPALLI, Bangalore (IN); Shyam Sunder MAHESHWARI, Jaipur (IN)

(73) Assignee: JIO PLATFORMS LIMITED, Ahmedabad (IN)

(21) Appl. No.: 19/102,899

(22) PCT Filed: Aug. 11, 2023
(86) PCT No.: PCT/IB2023/058143

§ 371 Date: Feb. 11, 2025

(30) Foreign Application Priority Data
Aug. 11, 2022 (IN) 202221045936

(51) Int. Cl. H04W 12/0431; H04W 12/041; H04W 12/72; H04W 92/10

(52) U.S. Cl. CPC H04W 12/0431; H04W 12/041; H04W 12/72; H04W 92/10

(57) ABSTRACT

The present disclosure provides a system and a method for secure communication between a device and an application server. The device sends a request for secure communication with the application server. Further, the system generates a security key based on the request and transmits the security key to a subscriber identity module (SIM) associated with the device over an over the air (OTA) interface. Further, the system generates a session key based on the security key and transmits the session key to the application server. The system enables the secure communication between the device and the application server based on the session key.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for secure communication in a wireless telecommunication system. More particularly, the present disclosure relates to a system and a method for secure communication between a device and an application server.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Secure communication is required when a new client is installed on a device and accesses a corresponding application server on a predefined IP/Port. Conventionally, secure mechanism for provisioning of transport layer security (TLS) keys on a newly installed device client for secure communication between device client and the corresponding application server. As of today, many of Telematic control unit (TCU) applications, Client Heartbeat Applications, and other Client side Data Collector Applications share a server certificate to the client and store one shared-secret on the device side client and server, which is common across all client applications or group of client applications. This shared secret is further used to generate ciphering keys for communication. If the shared secret is revealed by a hacker or any man-in-middle attack happens, then communication between clients and the application server is compromised. Some solutions use a token mechanism that may not be fully secured. Further, there is no standard way of storing keys/tokens inside the device application memory. Additionally, the solution may not be suitable for authenticating the client by the server as mutual authentication between the client and the server does not exist. Further, Internet of Things (IoT) devices do not include secure mechanisms for provisioning and storing of dynamic keys for mutual authentication and communication. Sometimes a client application developer may not be familiar with a transport layer security/secure socket layer (TLS/SSL) handshake protocol. Further, the client application developer may not know how to perform certificate exchanges and certificate validations. This may lead to bigger issues and pose a potential risk for the server and the client.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that uses a subscriber identity module (SIM) over the air (OTA) capability for secure provisioning of security keys on a SIM card application and uses the SIM card as the secure component to store the security keys.

It is an object of the present disclosure to provide a system and a method where a centralized key management service (KMS) server generates security keys and shares the security keys with a SIM OTA platform.

It is an object of the present disclosure to provide a system and a method where keys generated by the KMS server are shared with an application server and a device application for their mutual authentication and secure communication.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for establishing secure communication. The system includes a processor, and a memory operatively coupled to the processor, where the memory stores instructions to be executed by the processor. The processor receives a request from an application server. The request is for a secure communication between a computing device associated with one or more users and the application server. The processor generates a security key based on the request and transmits the security key to a subscriber identity module (SIM) configured with the computing device via an over the air (OTA) interface. The processor generates a session key based on the request and transmits the session key to the application server. The processor enables the secure communication between the computing device and the application server based on the session key.

In an embodiment, the security key may include an identifier with at least one of: an integrated circuit card identification number (ICCID) and an Applet identification (AID).

In an embodiment, the security key may be a transport layer security (TLS) key.

In an embodiment, the TLS key may include at least one of a symmetric key and an asymmetric key.

In an aspect, the present disclosure relates to a method for establishing secure communication. The method includes receiving, by a processor associated with a system, a request. The request is for a secure communication between a computing device associated with one or more users and the application server. The method includes generating, by the processor, a security key based on the request and transmitting the security key to a SIM configured with the computing device via an OTA interface. The method includes generating, by the processor, a session key based on the request and transmitting the session key to the application server. The method includes enabling, by the processor, the secure communication between the computing device and the application server based on the session key.

In an embodiment, the security key may include an identifier with at least one of an ICCID and an AID.

In an embodiment, the security key may be a TLS key.

In an embodiment, the TLS key may include at least one of a symmetric key and an asymmetric key.

In an aspect, a user equipment (UE) may include one or more processors communicatively coupled to a processor associated with a system. The one or more processors are coupled with a memory, where said memory stores instructions which, when executed by the one or more processors, cause the one or more processors to transmit a request to the processor via a network. The request is for a secure communication between the UE and an application server. The one or more processors encrypt data for the secure communication with a session key associated with the SIM and the application server. The one or more processors transmit the encrypted data to the application server. The processor is configured to receive the request from the UE via the application server. The processor is configured to generate a security key based on the request and transmit the security key to the SIM configured with the UE via an OTA interface. The processor is configured to generate the session key based on the request and transmit the session key to the application server. The processor is configured to enable the secure communication between the UE and the application server based on the session key.

In an aspect, a non-transitory computer readable medium including a processor with executable instructions causes the processor to receive a request from an application server. The request is for a secure communication between a computing device associated with one or more users and the application server. The processor generates a security key based on the request and transmits the security key to a SIM configured with the computing device via an OTA interface. The processor generates a session key based on the request and transmits the session key to the application server. The processor enables the secure communication between the computing device and the application server based on the session key.

In an aspect, the present disclosure relates to a system for establishing secure communication. The system includes a processor, and a memory operatively coupled to the processor. The memory stores instructions to be executed by the processor. The processor receives a request from a computing device associated with one or more users. The request is for a secure communication with the computing device. The processor generates a security key based on the request and transmits the security key to a SIM configured with the computing device via an OTA interface. The processor generates a session key based on the request and stores the session key in a secured database. The processor enables the secure communication with the computing device based on the session key.

In an embodiment, the security key may include an identifier with at least one of an ICCID and an AID

In an embodiment, the security key may be a TLS key.

In an embodiment, the TLS key may include at least one of a symmetric key and an asymmetric key.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (108), in accordance with an embodiment of the present disclosure.

FIG. 2 illustrates an example block diagram (200) of a proposed system (108), in accordance with an embodiment of the present disclosure.

FIG. 3 illustrates an example flow diagram (300) for secure communication using a key management service (KMS) server, in accordance with an embodiment of the present disclosure.

FIG. 4 illustrates an example flow diagram (400) for provisioning of transport layer security (TLS) keys to a subscriber identity module (SIM) over the air (OTA) platform, in accordance with an embodiment of the present disclosure.

FIG. 5 illustrates an example flow diagram (500) for an actual communication between the SIM and an application server once the TLS keys are provisioned, in accordance with an embodiment of the present disclosure

FIG. 6 illustrates an example flow diagram (600) for secure communication using an application server, in accordance with an embodiment of the present disclosure.

FIG. 7 illustrates an example computer system (700) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure uses a subscriber identity module (SIM) over the air (OTA) capability for securely provisioning of security keys on a SIM card application and considers the SIM card as a secure component to store the security keys. Each device client application may have its own unique key, which may be stored inside the SIM card. All the device clients may include dedicated separate keys, which are securely provisioned by the SIM OTA platform and stored inside the SIM card memory securely. One SIM Application (Applet) may host one key and the SIM may include multiple such applications or one SIM application may host multiple keys.

In an embodiment, a centralized key management service (KMS) server may generate the security keys and share with the SIM OTA platform. Each key shall be labelled with an identifier, for example, a key identifier [26 bytes]: [ICCID 10 bytes+Applet AID 16 bytes]. Further, the KMS server may store each key against this key identifier. Keys may be stored inside the KMS server and inside the SIM Applet at the SIM card. Once provisioned, the keys may never be revealed to an external world outside the KMS server and the SIM card. Only session keys generated using these base keys may be shared with application server and device application for their mutual authentication and secure communication. The KMS server may be connected with multiple application servers based on requirement(s). Further, one SIM may have multiple SIM applications, each hosting one key, or one application may host multiple keys. Based on an implementation, the SIM application may be used for all cryptography operations like mutual authentication and cipher/decipher or the SIM application may generate the session keys and share with the device application.

In an embodiment, whenever a device application wants to communicate with the application server, the device application may generate a random challenge/request/number used once (Nonce) and share the request with the application server along with the client identifier. The random challenge may be part of an algorithm used to generate dynamic session keys. The application server may pass this information to the KMS server to get the session keys. Once the application server gets the session key, the application server may send an OK response to the device application as an acknowledgement. Further, the device application may send this same request to the relevant SIM application to get the session key. The SIM application may use the corresponding key and a corresponding algorithm to generate the session key and share the session key with the device application. The corresponding algorithm may be based on hardware/software capability and requirements. Further, the corresponding algorithm may be common to a client side and a server side. Therefore, the application server and the device application may use session keys to securely communicate with each other. The proposed solution may be used to mutually authenticate a client and a server, where certificates and signed data may be exchanged to create the trust between the device application (client) and the application server.

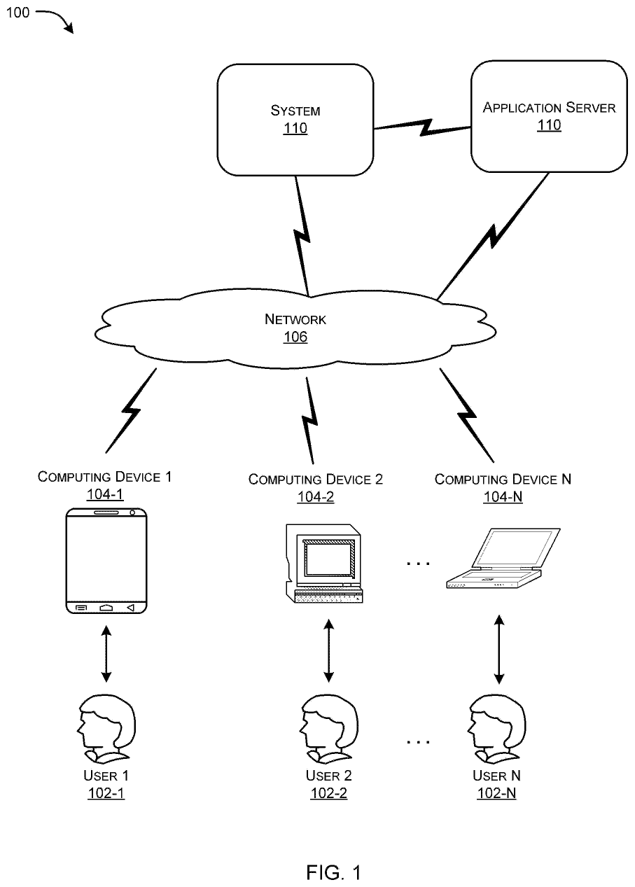

The various embodiments throughout the disclosure will be explained in more detail with reference to FIGS. 1-7.

FIG. 1 illustrates an example network architecture (100) for implementing a proposed system (108), in accordance with an embodiment of the present disclosure.

As illustrated in FIG. 1, the network architecture (100) may include a system (108). The system (108) may be connected to one or more computing devices (104-1, 104-2 . . . 104-N) via a network (106). The one or more computing devices (104-1, 104-2 . . . 104-N) may be interchangeably specified as a user equipment (UE) (104) and be operated by one or more users (102-1, 102-2 . . . 102-N). The computing device (104) may include a subscriber identity module (SIM) card. Further, the SIM card may include a SIM applet, a mechanism for communicating with the SIM. Further, the one or more users (102-1, 102-2 . . . 102-N) may be interchangeably referred as a user (102) or users (102). In an embodiment, the system (108) may include a centralized key management service (KMS) server. In another embodiment, the system (108) may be associated with the KMS server. In an embodiment, the KMS server may generate security keys and/or session keys for establishing secure communication between an application server (110) and the computing device (104). In an alternate embodiment, the application server (110) may generate security keys and/or session keys for establishing secure communication with the computing device (104).

In an embodiment, the present solution allows over the air (OTA) provisioning of dynamic keys and stores them securely inside the SIM card. The proposed solution is applicable to all types of universal integrated circuit card (UICC)/universal subscriber identity module (USIM)/SIM/eUICC cards. For example, a long-term evolution (LTE) SIM card may support symmetric cryptography. Here, a mobile network operator (MNO) SIM OTA platform may incorporate secure channel protocol 81 (SCP81) (transport layer security (TLS) 1.2 or TLS1.3) or SCP80 (SMS) for secure communication between the SIM card and MNO SIM OTA platform. This may ensure that the dynamic keys are securely sent to a SIM card application.

In an embodiment, the present disclosure may be extended to IoT computing devices, where the system (108) may secure the communication between the IoT application on the computing device (104) and an IoT application server. Conventionally, IoT applications do not include secure mechanisms for provisioning and storing the dynamics keys. The proposed solution provides a secure way of provisioning and storing dynamic keys, as keys may be stored inside a secured component. The proposed solution may also be applicable for low-cost IoT devices which may include constrained support for cryptography to be performed by the SIM application.

In an embodiment, secure communication between the IoT application on a device and a corresponding SIM Applet on the SIM may be managed by an Access Rule Application (ARA) concept. The MNO SIM OTA may add one rule in the ARA for mapping of each SIM Applet to its corresponding IoT application on the device (104). This may enforce that only an intended IoT application on the device (104) may communicate with the SIM application on the SIM card. ARA is not required when Client Application on Device is part of Device Firmware (Device OS), as it will have root access and can have APDU exchange with SIM card. Further, current SIM cards are Java cards that support symmetric cryptography and ARA as well. If the device does not support ARA, then an (advanced technology+converged security and information management system) (AT+CSIM) command may be used for communication between the device application and SIM card application (as stated above, where the application may be part of device firmware).

In an embodiment, the computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from the user (102) such as a touch pad, touch-enabled screen, electronic pen, and the like may be used. A person of ordinary skill in the art will appreciate that the computing devices (104) may not be restricted to the mentioned devices and various other devices may be used.

In an embodiment, the computing devices (104) may include IoT devices. IoT devices collect data from their sensors and use software for functioning. IoT devices may connect to a central server, to get more information. Further, IoT devices may compare and send data to servers to collect information and further connect to other IoT devices for various functionalities.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive a request from an application server (110). The request may be for a secure communication between the computing device (104) associated with one or more users (102) and the application server (110).

In an embodiment, the system (108) may include or be associated with the KMS server. The request may include an identifier associated with the SIM. The identifier may include but not limited to an integrated circuit card identification number (ICCID) and an Applet Identifier (Applet ID) associated with the SIM.

In an embodiment, the system (108) may generate a security key based on the request and transmit the security key to the SIM configured with the computing device (104) via an over the air (OTA) interface. The security key generated by the system (108) may be transport layer security (TLS) key. The TLS key may include at least one of a symmetric key and an asymmetric key.

In an embodiment, the system (108) may generate a session key based on the request and transmit the session key to the application server (110). The system (108) may enable the secure communication between the computing device (104) and the application server (110) based on the session key.

In another embodiment, the system (108) may be associated with the application server (110). The system (108) may receive a request from the computing device (104) associated with one or more users (102). The request may be for a secure communication with the computing device (104). The system (108) or as such the application server (110) may generate a security key based on the request and transmit the security key to the SIM configured with the computing device (104) via the OTA interface. The system (108) may generate a session key based on the request and store the session key to the computing device (104) in a secured database. Further, the system (108) may enable the secure communication between the computing device (104) and the application server (110) based on the session key.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

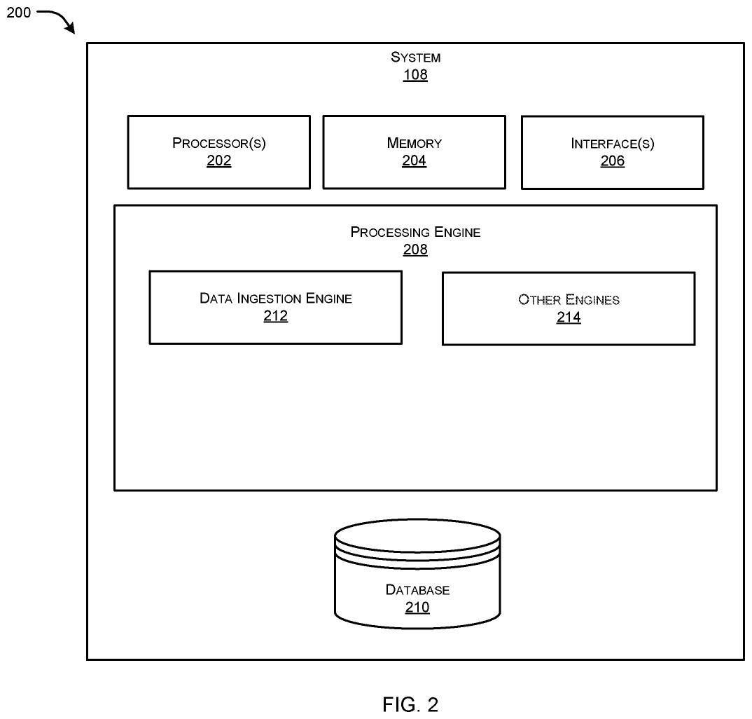

FIG. 2 illustrates an example block diagram (200) of a proposed system (108), in accordance with an embodiment of the present disclosure.

Referring to FIG. 2, the system (108) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (108). Examples of such components include, but are not limited to, processing engine(s) (208) and a database (210), where the processing engine(s) (208) may include, but not be limited to, a data ingestion engine (212) and other engine(s) (214). In an embodiment, the other engine(s) (214) may include, but not limited to, a data management engine, an input/output engine, a notification engine, and a KMS engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the processor (202) may receive a request via the data ingestion engine (212). The processor (202) may store the request in the database (210). In some embodiments, the system (108) may include the KMS engine. The request may be for a secure communication between the computing device (104) associated with one or more users (102) and the application server (110).

In an embodiment, the processor (202) may include or be associated with the KMS server. The request may include an identifier associated with the SIM. The identifier may include but not limited to an ICCID and an Applet AID associated with the SIM.

In an embodiment, the processor (202) may generate a security key based on the request and transmit the security key to the SIM configured with the computing device (104) via an OTA interface. The security key generated by the processor (202) may be TLS key. The TLS key may include at least one of a symmetric key and an asymmetric key.

In an embodiment, the processor (202) may generate a session key based on the request and transmit the session key to the application server (110). The processor (202) may enable the secure communication between the computing device (104) and the application server (110) based on the session key.

In another embodiment, the processor (202) may be associated with the application server (110). The processor (202) may receive a request from the computing device (104) associated with one or more users (102). The request may be for a secure communication with the computing device (104). The processor (202) may generate a security key based on the request and transmit the security key to the SIM configured with the computing device (104) via the OTA interface. The processor (202) may generate a session key based on the request and store the session key in a secured database associated with the application server (110). Further, the processor (202) may enable the secure communication with the computing device (104) based on the session key.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

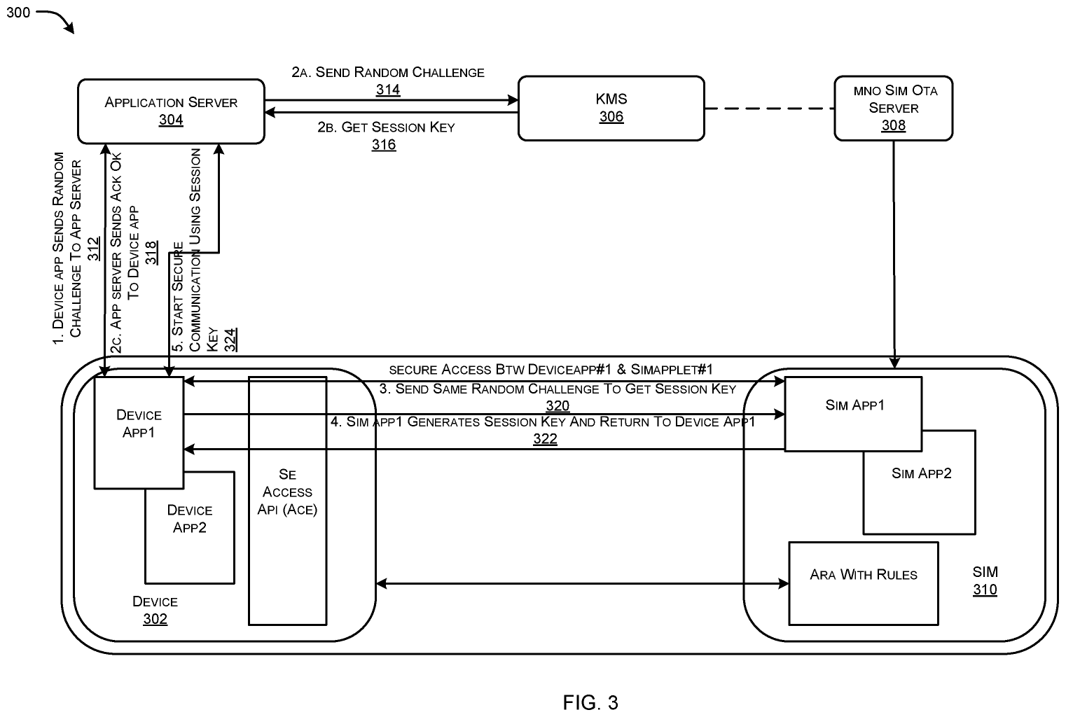

FIG. 3 illustrates an example flow diagram (300) for secure communication using a key management service (KMS) server, in accordance with an embodiment of the present disclosure.

In an embodiment, a KMS server (306) may generate keys as per a request from an application server (304) and share the keys with a SIM (310) associated with a device (302) via an MNO SIM OTA server (308). It may be appreciated that the application server (304) and the device (302) may be similar to the application server (110) and the computing device (104) of FIG. 1, respectively.

As illustrated in FIG. 3, the flow diagram (300) may include the following steps.

At step 312: A device application from the computing device (302) may send a random challenge to the application server (304).

At step 314: The application server (304) may send the random challenge to the KMS server (306). The random challenge may include a request from the computing device (302) for establishing secure communication with the application server (304).

At step 316: The KMS server (306) may generate security keys and session keys based on the request from the application server (304) and transmit the session keys to the application server (304). In an embodiment, the KMS server (306) may transmit the security keys to SIM (310) associated with the computing device (302) via the OTA server (308). In an embodiment, the OTA server (308) may push an applet on the SIM (310) with its dedicated security keys. For example, the security key may be a TLS key, i.e. a symmetric key or asymmetric key. Further, the OTA server (308) may add a rule in the ARA for newly installed applet and relevant application (e.g., IoT application) on the device (302).

At step 318: The application server (304) may send an acknowledge to the computing device (302).

At step 320: The computing device (302) may send the same random challenge to the SIM (310) to receive the session key.

At step 322: The SIM application within the SIM (310) may generate the session key based at least on the security keys received from the KMS server (306) via the OTA server (308), and transmit the session key to the computing device (302). Therefore, a secure communication may be established between the computing device (302) and the application server (304) based on the session key.

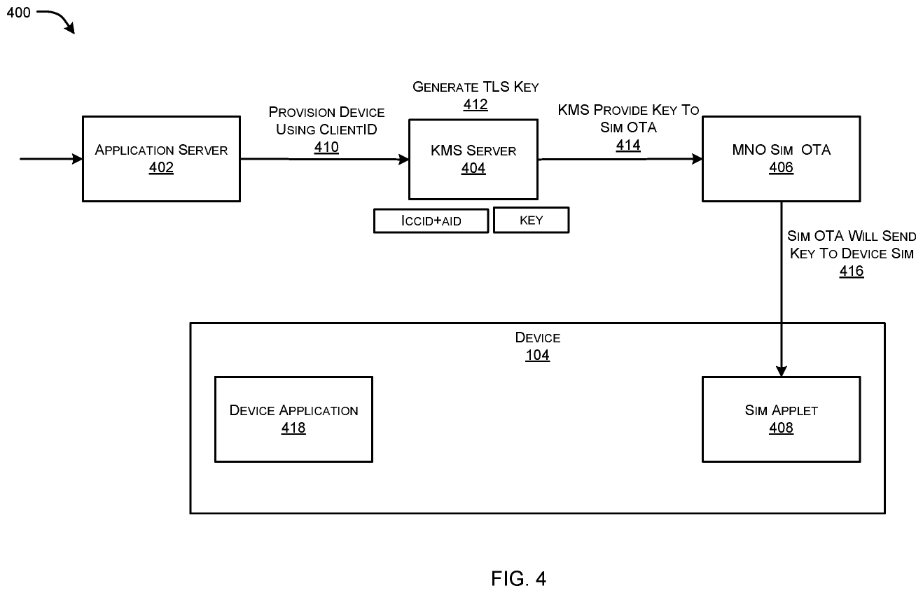

FIG. 4 illustrates an example flow diagram (400) for provisioning of transport layer security (TLS) keys to a subscriber identity module (SIM) over the air (OTA) platform, in accordance with an embodiment of the present disclosure.

As illustrated in FIG. 4, the flow diagram (400) may include the following steps.

At step 410: An application server (402) may receive a request from a computing device (104). The application server (402) may send the request to a KMS server (404) with a client identifier (ID). In some embodiments, the client ID may include an identifier with ICCID and AID information from the computing device (104).

At step 412: The KMS server (404) may generate a security key, i.e., TLS key based on the identifier received in the request. The TLS key may be a symmetric or an asymmetric key for encryption.

At step 414: The KMS server (404) may send the TLS key to an MNO SIM OTA server (406).

At step 416: The MNO SIM OTA server (406) may send the TLS key to a SIM applet (408) configured in the computing device (104).

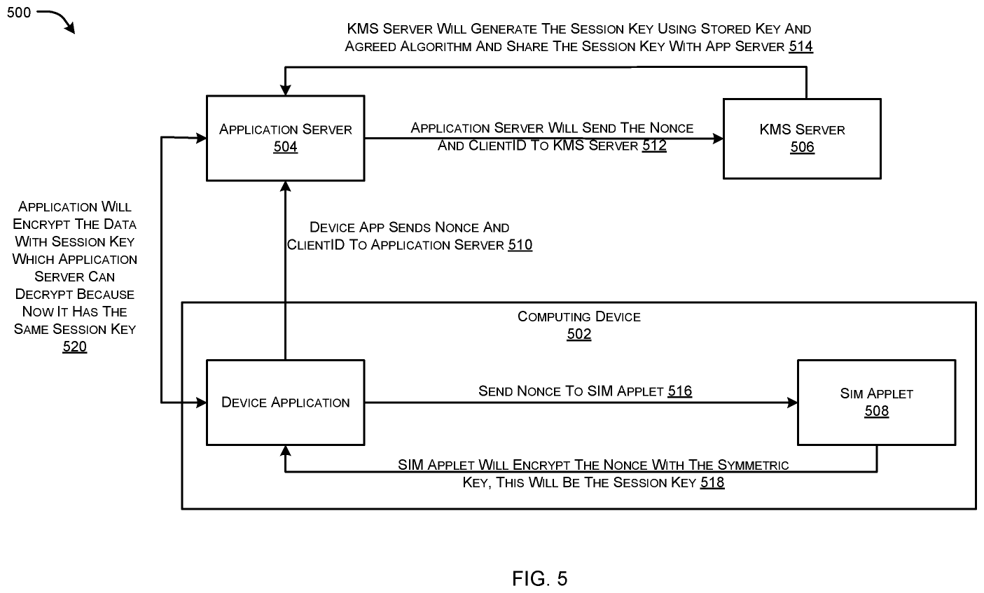

FIG. 5 illustrates an example flow diagram (500) for an actual communication between the SIM and an application server once the TLS keys are provisioned, in accordance with an embodiment of the present disclosure.

As illustrated in FIG. 5, the flow diagram (500) may include the following steps.

At step 510: A device application in a computing device (502) may send a Nonce and a client ID to an application server (504).

At step 512: The application server (504) may send the Nonce and the client ID to a KMS server (506).

At step 514: The KMS server (506) may generate a session key using a security key and an algorithm and share the session key with the application server (504). The KMS server (506) may store each security key against a key identifier. Security keys may be stored inside the KMS server (506) and inside a SIM Applet associated with the computing device (502). Once provisioned, the security keys may never be revealed outside the KMS server (506) and the SIM Applet. Only session keys generated using these security keys may be shared with the application server (504) and the computing device (502) for their mutual authentication and secure communication. The security keys may include an asymmetric key or a symmetric key.

At step 516: The device application (502) may send the Nonce to a SIM applet (508) configured in the device application (502).

At step 518: The SIM applet (508) may encrypt the Nonce with the security key, for example, a symmetric key/asymmetric key, which will be the session key, and provide the session key to the device application (502).

At step 520: The computing device (502) may start sending data to the application server (504) by encrypting the data with the obtained session key. The application server (504) may be able to decrypt the data using the session key as the application server (504) possesses the same session key from the KMS server (506) as the device application (502).

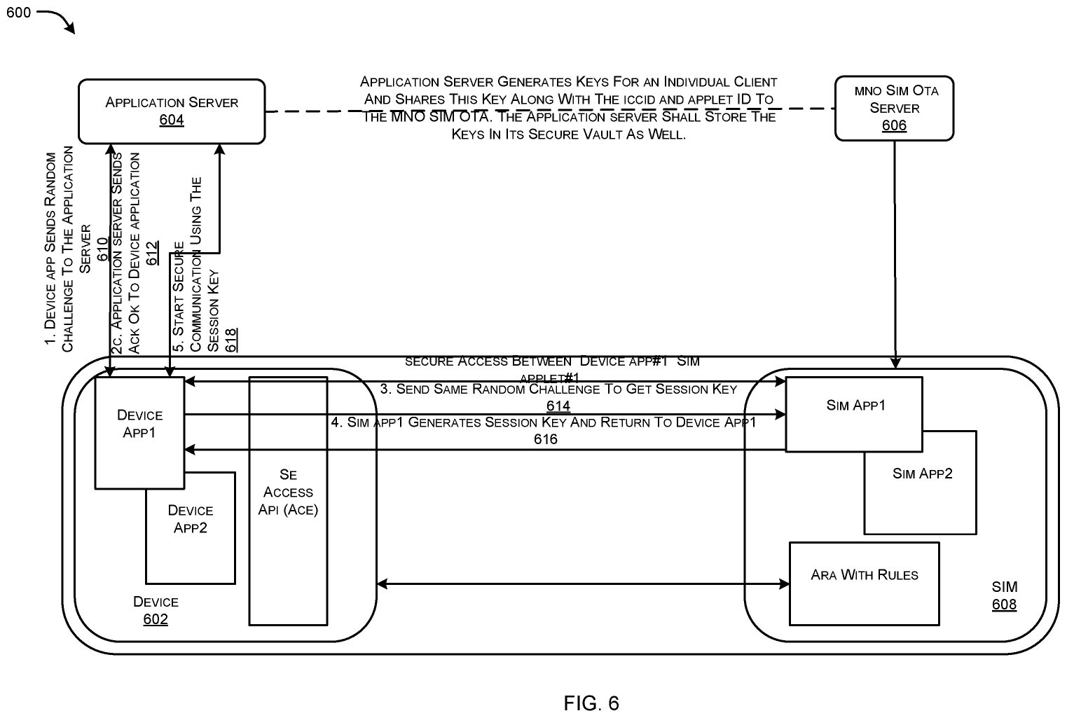

FIG. 6 illustrates an example flow diagram (600) for secure communication using an application server, in accordance with an embodiment of the present disclosure.

In an embodiment, an application server (604) may generate keys for an individual client device and share keys with the ICCID/Applet ID to an MNO SIM OTA server (606). The application server (604) may store the generated keys in a secure vault.

As illustrated in FIG. 6, the flow diagram (600) may include the following steps.

At step 610: A device application (602) may send a random challenge to the application server (604).

At step 612: The application server (604) may generate security keys and/or session keys for an individual client (e.g., 602) and share the security keys and/or session keys along with the ICCID/Applet ID to the MNO SIM OTA server (606). The application server (604) may store the session keys in its secret vault as well.

At step 612: The application server (604) may send an acknowledge to the device application (602).

At step 614: The device application (602) may send the random challenge to a SIM (608). A PUSH Applet on the SIM (608) may store a dedicated security key, i.e. a symmetric or an asymmetric key associated with the individual key in its vault. Further, the SIM (608) may add a rule in the ARA for a newly installed applet and a relevant application (for example, an IoT application) on the device application (602).

At step 616: A SIM application in the SIM (608) may generate the session key and return the session key to the device application (602).

At step 618: The device application (602) may start communication with the application server (604) using the session key.

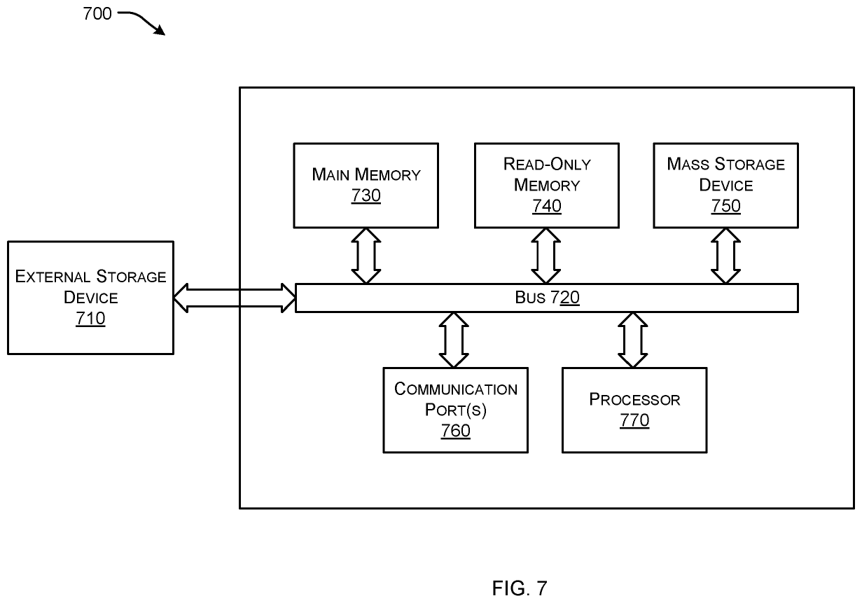

FIG. 7 illustrates an exemplary computer system (700) in which or with which embodiments of the present disclosure may be implemented.

As shown in FIG. 7, the computer system (700) may include an external storage device (710), a bus (720), a main memory (730), a read-only memory (740), a mass storage device (750), a communication port(s) (760), and a processor (770). A person skilled in the art will appreciate that the computer system (700) may include more than one processor and communication ports. The processor (770) may include various modules associated with embodiments of the present disclosure. The communication port(s) (760) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (760) may be chosen depending on a network, such as a Local Area Network (LAN), Wide Area Network (WAN), or any network to which the computer system (700) connects.

In an embodiment, the main memory (730) may be Random Access Memory (RAM), or any other dynamic storage device commonly known in the art. The read-only memory (740) may be any static storage device(s) e.g., but not limited to, a Programmable Read Only Memory (PROM) chip for storing static information e.g., start-up or basic input/output system (BIOS) instructions for the processor (770). The mass storage device (750) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (720) may communicatively couple the processor(s) (770) with the other memory, storage, and communication blocks. The bus (720) may be, e.g. a Peripheral Component Interconnect PCI)/PCI Extended (PCI-X) bus, Small Computer System Interface (SCSI), (USB), or the like, for connecting expansion cards, drives, and other subsystems as well as other buses, such a front side bus (FSB), which connects the processor (770) to the computer system (700).

In another embodiment, operator and administrative interfaces, e.g., a display, keyboard, and cursor control device may also be coupled to the bus (720) to support direct operator interaction with the computer system (700). Other operator and administrative interfaces can be provided through network connections connected through the communication port(s) (760). Components described above are meant only to exemplify various possibilities. In no way should the aforementioned exemplary computer system (700) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method that uses a subscriber identity module (SIM) over the air (OTA) capability for secure provisioning of security keys on a SIM card application and uses the SIM card as the secure component to store the security key.

The present disclosure provides a system and a method where a centralized key management service (KMS) server generates security keys and shares the security keys with the SIM OTA platform.

The present disclosure provides a system and a method where keys generated by the KMS server are shared with an application server and a device application for their mutual authentication and secure communication.

We claim:

1. A system (108) for establishing secure communication, the system (108) comprising:
a processor (202); and
a memory (204) operatively coupled with the processor (202), wherein said memory (204) stores instructions which, when executed by the processor (202), cause the processor (202) to:
receive a request from an application server (110), wherein the request is for a secure communication between a computing device (104) associated with one or more users (102) and the application server (110);
generate a security key based on the request and transmit the security key to a subscriber identity module (SIM) configured with the computing device (104) via an over the air (OTA) interface;
generate a session key based on the request and transmit the session key to the application server (110); and
enable the secure communication between the computing device (104) and the application server (110) based on the session key.

2. The system (108) as claimed in claim 1, wherein the security key comprises an identifier with at least one of: an integrated circuit card identification number (ICCID) and an Applet identification (AID).

3. The system (108) as claimed in claim 1, wherein the security key is a transport layer security (TLS) key.

4. The system (108) as claimed in claim 3, wherein the TLS key comprises at least one of: a symmetric key and an asymmetric key.

5. A method for establishing secure communication, the method comprising:
receiving, by a processor (202) associated with a system (108), a request from an application server (110), wherein the request is for a secure communication between a computing device (104) associated with one or more users (102) and the application server (110);
generating, by the processor (202), a security key based on the request and transmitting the security key to a subscriber identity module (SIM) configured with the computing device (104) via an over the air (OTA) interface;
generating, by the processor (202), a session key based on the request and transmitting the session key to the application server (110); and
enabling, by the processor (202), the secure communication between the computing device (104) and the application server (110) based on the session key.

6. The method as claimed in claim 5, wherein the security key comprises an identifier with at least one of: an integrated circuit card identification number (ICCID) and an Applet identification (AID).

7. The method as claimed in claim 5, wherein the security key is a transport layer security (TLS) key.

8. The method as claimed in claim 7, wherein the TLS key comprises at least one of: a symmetric key and an asymmetric key.

9. A user equipment (UE) (104), comprising:
one or more processors communicatively coupled to a processor (202) associated with a system (108), wherein the one or more processors are coupled with a memory, and wherein said memory stores instructions which, when executed by the one or more processors, cause the one or more processors to:
transmit a request to the processor (202) via a network (106), wherein the request is for a secure communication between the UE (104) and an application server (110);
encrypt data for the secure communication with a session key associated with a subscriber identity module (SIM) and the application server (110); and
transmit the encrypted data to the application server (110), wherein the processor (202) is configured to:
receive the request from the UE (104) via the application server (110);
generate a security key based on the request and transmit the security key to the SIM via an over the air (OTA) interface;
generate the session key based on the request and transmit the session key to the application server (110); and
enable the secure communication between the UE (104) and the application server (110) based on the session key.

10. A non-transitory computer readable medium comprising a processor with executable instructions, causing the processor to:
receive a request from an application server (110), wherein the request is for a secure communication between a computing device (104) associated with one or more users (102) and the application server (110);
generate a security key based on the request and transmit the security key to a subscriber identity module (SIM) configured with the computing device (104) via an over the air (OTA) interface;
generate a session key based on the request and transmit the session key to the application server (110); and
enable the secure communication between the computing device (104) and the application server (110) based on the session key.

11. A system (108) for establishing secure communication, the system (108) comprising:
a processor (202); and
a memory (204) operatively coupled with the processor (202), wherein said memory (204) stores instructions which, when executed by the processor (202), cause the processor (202) to:
receive a request from a computing device (104) associated with one or more users (102), wherein the request is for a secure communication with the computing device (104);
generate a security key based on the request and transmit the security key to a subscriber identity module (SIM) configured with the computing device (104) via an over the air (OTA) interface;
generate a session key based on the request and store the session key in a secured database; and
enable the secure communication with the computing device (104) based on the session key.

12. The system (108) as claimed in claim 11, wherein the security key comprises an identifier with at least one of: an integrated circuit card identification number (ICCID) and an Applet identification (AID).

13. The system (108) as claimed in claim 11, wherein the security key is a transport layer security (TLS) key.

14. The system (108) as claimed in claim 13, wherein the TLS key comprises at least one of: a symmetric key and an asymmetric key.
